(19) United States
(12) Patent Application Publication
(10) Pub. No.: US 2005/0216268 A1
(43) Pub. Date: Sep. 29, 2005

(54) Speech to DTMF conversion

(75) Inventor: Kenneth Kannappan, Palo Alto, CA (US)

Correspondence Address: PLANTRONICS, INC., 345 ENCINAL STREET, P.O. BOX 635, SANTA CRUZ, CA, 95060-0635, US

(73) Assignee: Plantronics, Inc., A DELAWARE CORPORATION, Santa Cruz, CA (US)

(21) Appl. No.: 10/812,175

(22) Filed: Mar. 29, 2004

(51) Int. Cl. H04M 1/64

(52) U.S. Cl. 704/270

(57) ABSTRACT

A headset or headset system and method utilizing voice recognition technology for translating spoken digits, numbers, and/or letters to in-band dual tone multi-frequency (DTMF) tones to facilitate, for example, navigation of DTMF-controlled systems such as voice mail are disclosed. The headset system generally includes a speech recognition engine that, when activated, receives audio signals from a headset microphone and interprets the audio signals representing digits, letters, and/or numbers, and a DTMF tone generator that generates in-band DTMF tones representing the interpreted audio signals. The speech recognition engine may be activated via a DTMF activation button or voice command. A voice synthesizer may be provided in order to confirm accuracy of the interpreted audio signals. The in-band DTMF tone generator generally generates DTMF tones with a direct correspondence to the interpreted audio signals. The speech recognition engine may further be configured to interpret a predefined set of commands and/or user responses.

### BACKGROUND OF THE INVENTION

1. Field of the Invention

The present invention relates generally to headsets for use in telecommunications, telephony, and/or multimedia applications. More specifically, a headset or headset system and method utilizing voice recognition technology for translating spoken digits, numbers, and/or letters to in-band dual tone multi-frequency (DTMF) tones to facilitate, for example, navigation of DTMF-controlled systems such as voice mail are disclosed.

2. Description of Related Art

Communication headsets are used in numerous applications and are particularly effective for telephone operators, radio operators, aircraft personnel, and for other users for whom it is desirable to have hands-free operation of communication systems. Accordingly, a wide variety of conventional headsets are available.

A headset user may connect to an automated DTMF-controlled telephone answering system. Examples of automated telephone answering systems employing DTMF-controlled applications include voicemail systems, systems that provide various information such as flight status, order status, etc., and various other systems. For example, in a DTMF-controlled voicemail user interface, the user may press different numbered keys to enter the voicemail box number and the password, and/or to sort, play, delete, fast forward and/or rewind messages, etc.

To navigate through the menus and options, the user may be required to manually enter the requested information or selection using the telephone dial pad in order to generate the necessary DTMF tones so as to navigate through the DTMF-controlled system. In some environments, the user may not easily access a dial pad to navigate through DTMF-controlled systems, such as when a dial pad may not be near the headset user as may be the case with a wireless headset and/or when the user is using the headset while driving or performing other activities. Such manual actions by the user thus decrease the effectiveness of the heads-free headset.

Thus, it would be desirable to provide a headset or headset system to facilitate the user in navigating through DTMF-controlled systems. Ideally, the headset or headset system improves the effectiveness of and better maintains a hands-free user environment.

### SUMMARY OF THE INVENTION

A headset or headset system and method utilizing voice recognition technology for translating spoken digits, numbers, and/or letters to in-band dual tone multi-frequency (DTMF) tones to facilitate, for example, navigation of DTMF-controlled systems such as voice mail are disclosed. It should be appreciated that the present invention can be implemented in numerous ways, including as a process, an apparatus, a system, a device, or a method. Several inventive embodiments of the present invention are described below.

The headset system generally includes a speech recognition engine that, when activated, is configured to receive audio signals from a headset microphone and to interpret the audio signals representing digits, letters, and/or numbers, and an in-band DTMF tone generator in communication with the speech recognition engine and configured to generate in-band DTMF tones representing the interpreted audio signals. The speech recognition engine and/or the in-band DTMF tone generator may be contained in the headset and/or in the headset base unit. The speech recognition engine may be activated via a DTMF activation button or a user voice command. The headset system may also include a voice synthesizer to synthesize the interpreted audio signals in order to confirm accuracy of the interpreted audio signals. The in-band DTMF tone generator generally generates in-band DTMF tones with a direct correspondence to the interpreted audio signals, i.e., when the user speaks the digit “two” or the letter “a,” “b,” or “c,” the in-band DTMF tone generator generates the corresponding tone for “two.” The speech recognition engine may further be configured to interpret a predefined set of commands and/or user responses such as “cancel,” “yes,” “no,” and the like.

A method for navigating a DTMF-controlled system generally includes activating a speech recognition engine, interpreting speech received via a microphone from a user by the speech recognition engine, the speech recognition engine being configured to interpret the speech representing digits, letters, and/or numbers, and generating and transmitting in-band DTMF tones representing the interpreted speech by an in-band DTMF tone generator in communication with the speech recognition engine. Prior to the generating and transmitting, the method may further include confirming accuracy of the speech interpreted by the speech recognition engine by generating the interpreted speech via a voice synthesizer. The speech recognition engine may further be configured to interpret a predefined set of commands and/or user responses.

According to another embodiment, a method generally includes connecting to a DTMF-controlled system, in which navigation through the DTMF-controlled system is via transmission of DTMF tones thereto, interpreting speech by a speech recognition engine configured to receive speech from a user, and generating and transmitting in-band DTMF tone to the DTMF-controlled system, the in-band DTMF tones being a translation of the interpreted speech of digits, letters, and/or numbers.

These and other features and advantages of the present invention will be presented in more detail in the following detailed description and the accompanying figures which illustrate by way of example principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a block diagram of an illustrative headset system utilizing voice recognition technology for translating spoken digits/numbers/letters to in-band DTMF tones.

FIG. 2 is a block diagram of an alternative headset system utilizing voice recognition technology for translating spoken digits/numbers/letters to in-band DTMF tones.

FIG. 3 is a flow chart illustrating a method for translating spoken digits/numbers/letters to in-band DTMF tones using voice recognition technology.

### DESCRIPTION OF SPECIFIC EMBODIMENTS

A headset or headset system and method utilizing voice recognition technology for translating spoken digits, numbers, and/or letters to in-band dual tone multi-frequency (DTMF) tones to facilitate, for example, navigation of DTMF-controlled systems such as voice mail are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

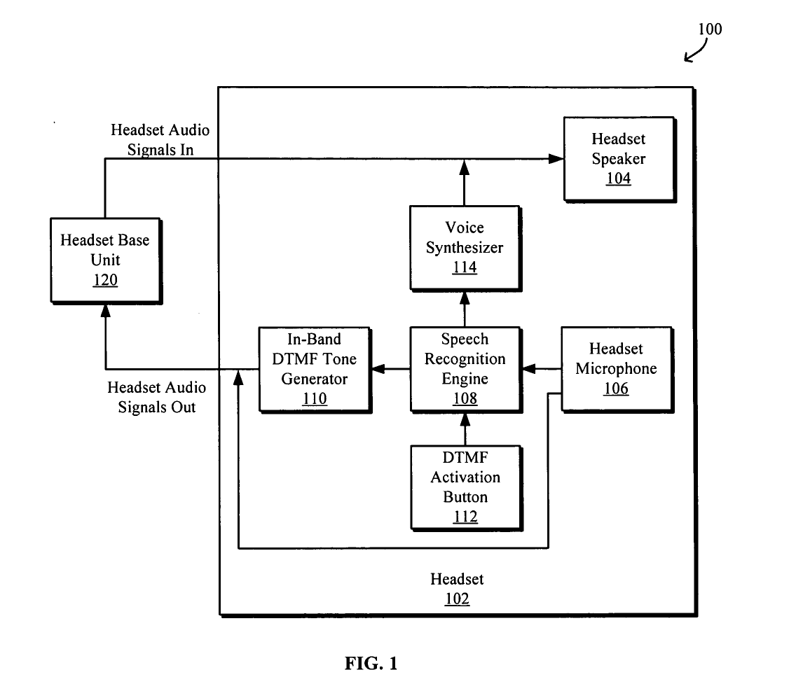

FIG. 1 is a block diagram of an illustrative headset system 100 utilizing voice recognition technology for translating spoken digits, numbers and/or letters to in-band DTMF tones to facilitate the headset users in hands-free navigation through DTMF-controlled systems. Only those components of the headset relevant to the system and method of translating spoken digits/numbers/letters to in-band DTMF tones are shown and described for purposes of clarity as various other conventional components of the headset are well known. As shown, the headset 102 includes a headset speaker or receiver 104 that receives headset audio signals from a headset base unit 120 and a headset microphone or transmitter 106 that transmits headset audio signals to the headset base unit 120. The headset base unit 120 may be any suitable unit such as a conventional desktop telephone, a cellular telephone, and/or a computer executing an application such as a softphone application. The headset 102 may be in communication with the headset base unit 120 via a wired or a wireless connection. In the case of a wireless connection, the headset 102 communicates with the headset base unit 120 wirelessly using, for example, Bluetooth, or various other suitable wireless technologies.

The headset 102 also includes a voice or speech recognition engine 108 in communication with the headset microphone 106 that, when activated, performs speech recognition on audio signals received from the headset microphone 106. The speech recognition engine 108 is in turn in communication with an in-band DTMF tone generator 110 that receives data from the speech recognition engine 108 and generates in-band DTMF tones for transmission.

The speech recognition engine 108 may be activated and deactivated by, for example, a DTMF activation button 112 as may be provided on the headset or on a connector (not shown) between the headset 102 and the headset base unit 120, for example. As another example, the speech recognition engine 108 may alternatively or additionally be activated and deactivated by voice commands from the user, as transmitted to the speech recognition engine 108 via the headset microphone 106. The voice activation and deactivation commands are preferably simple predefined phrases such as “activate touch tone” and “deactivate touch tone” or any other suitable commands. Where the speech recognition engine 108 is or can be activated and deactivated with the user's voice commands, preferably all audio signals transmitted by the headset microphone 106 are routed through the speech recognition engine 108 so that the speech recognition engine 108 may monitor the signals for the activation/deactivation voice commands. As yet another example, the speech recognition engine 108 may alternatively or additionally be automatically activated such as by programming the telephone numbers that connect to DTMF-controlled systems. For example, the numbers for the user's DTMF-controlled voicemail system, a DTMF-controlled airline flight status check, and/or a DTMF-controlled call routing system are examples of telephone numbers that can be programmed to automatically trigger activation of the speech recognition engine 108.

Once activated, the speech recognition engine 108 interprets the user's speech to generate in-band DTMF tones corresponding to the user's speech. The speech recognition engine 108 may be configured to interpret the user's spoken digits, numbers and/or letters. In the case of numbers, the speech recognition engine 108 may be configured to interpret, for example, “thirty-nine,” as the combination of the digits 3 followed by 9. The speech recognition engine 108 may additionally be configured to interpret the user's spoken letters, translate them to the corresponding number on the dial pad to generate the in-band DTMF tones corresponding to the spoken letters. As is well known, the dial pad number 2 (and thus the corresponding DTMF tone) corresponds to letters A, B, and C, dial pad number 3 (and thus the corresponding DTMF tone) corresponds to letters D, E, and F, etc. Such a configuration may be useful, for example, when an automated DTMF-controlled call routing system requires the user to dial the name of the person the user wishes to reach. Depending on the specifics relating to the features and functionalities implemented by the headset system 100, the speech recognition engine 108 may be also configured to interpret simple commands such as “activate touch tone,” “deactivate touch tone,” “cancel,” “yes,” “no,” etc. and/or the special keys on the dial pad such as “pound” and “star.” The speech recognition engine 108 may be further configured to interpret specific user-programmed commands such as “voicemail” and “PIN” to facilitate the user in navigating through frequently used DTMF-controlled applications such as to facilitate the user in logging in a DTMF-controlled voicemail system. To better simulate the user dialing using the dial pad, the DTMF tones generated by the in-band DTMF tone generator 110, in addition to being transmitted in-band, may be fed back to headset speaker 104.

The speech recognition engine 108 may be based on, for example, a general purpose programmable digital signal processor (DSP) or an application-specific integrated circuit (ASIC). The speech recognition engine 108 may be speaker-dependent or speaker-independent in interpreting the user's speech. In other words, the speech recognition engine 108 may be trained to the user's voice or multiple users' voices or may be configured to interpret spoken words independent of the speaker.

The speech recognition engine 108 may be configured, e.g., by design, by factory preset, and/or by the user, to receive, interpret and generate corresponding DTMF tones for all spoken words (digits, numbers and/or letters, for example) together for each step of the navigation of the DTMF-controlled system. For example, in response to the user speaking “8 3 1 5 5 5 1 0 0 0 done,” the speech recognition engine 108 may interpret all 10 digits and cause the in-band DTMF generator 110 to generate and transmit all 10 DTMF tones corresponding to the 10 digits. In the case of the user “dialing” the name of the person the user wishes to reach as requested by the DTMF-controlled call routing system, the user may speak “S M I T H J O H N Done,” and the speech recognition engine 108 may then interpret all the letters and cause the in-band DTMF generator 110 to generate and transmit all the DTMF tones corresponding to the letters. It is noted that letters and numbers may be combined in one user input. As in the examples above, the user may signal to the system that the user is done speaking all the digits and/or letters with a specific command, e.g., “done.” The system may also determine that the user is done speaking after a predetermined period of silence.

Alternatively, the speech recognition engine 108 may be configured, e.g., by design, by factory preset, and/or by the user or, to receive and interpret each spoken word one at a time such that as each word is spoken, the speech recognition engine 108 interprets the word and causes the in-band DTMF generator 110 to generate and transmit the single corresponding DTMF tone. In other words, as the user speaks each digit or letter, the in-band DTMF generator 110 generates and transmits the corresponding DTMF tone.

Accuracy of the speech recognition engine 108 may optionally be confirmed with the user by having the speech recognition engine 108 speak back the spoken digits, numbers and/or letters through a voice synthesizer 114 and requesting confirmation prior to generating and transmitting the in-band DTMF tone. In particular, the speech recognition engine 108 may be in communication with a voice synthesizer 114 which is in turn in communication with the headset speaker 104. The user may confirm or disconfirm by speaking, for example, “yes” or “no” which may also be interpreted and processed by the speech recognition engine 108. As another example, the headset 102 may provide buttons that the user may utilize to confirm and disconfirm.

As is evident, the headset system 100 incorporating the speech recognition engine 108 and in-band DTMF tone generator 110 facilitates in maintaining true hands-free operation as the user does not need to manually use a dial pad to navigate through a DTMF-controlled system such as voicemail or an automated call routing system. Such a headset system 100 is particularly useful for wireless headsets such as Bluetooth headsets. Typically, the speech recognition engine 108 and the in-band DTMF tone generator 110 are utilized after the call has been initiated, i.e., after the headset is online, in order to facilitate the user in hands-free navigation through a DTMF-controlled system. It is noted that the speech recognition engine 108 and/or the in-band DTMF tone generator 110 may also be employed, either individually or in combination, for additional other features of the headset system 100.

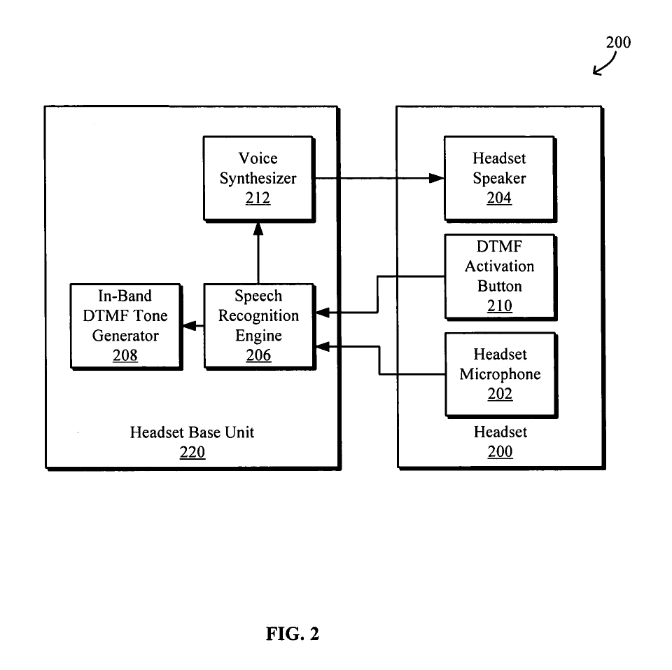

FIG. 2 is a block diagram of an alternative headset system 200 in which the speech recognition engine 208 and the in-band DTMF tone generator 210 are incorporated into the headset base unit 220, such as a base telephone or a cellular telephone, rather than in the headset 202. The optional voice synthesizer 214 may be similarly be located in the headset base unit 220. The transmission and reception of headset audio signals to the headset speaker 204 and from the headset microphone 206, respectively, are similar to those described above with reference to FIG. 1. The optional DTMF activation button 212 may be located on the headset 202 to facilitate ease of activation by the user although the DTMF activation button 212 may similarly be located on the headset base unit 220.

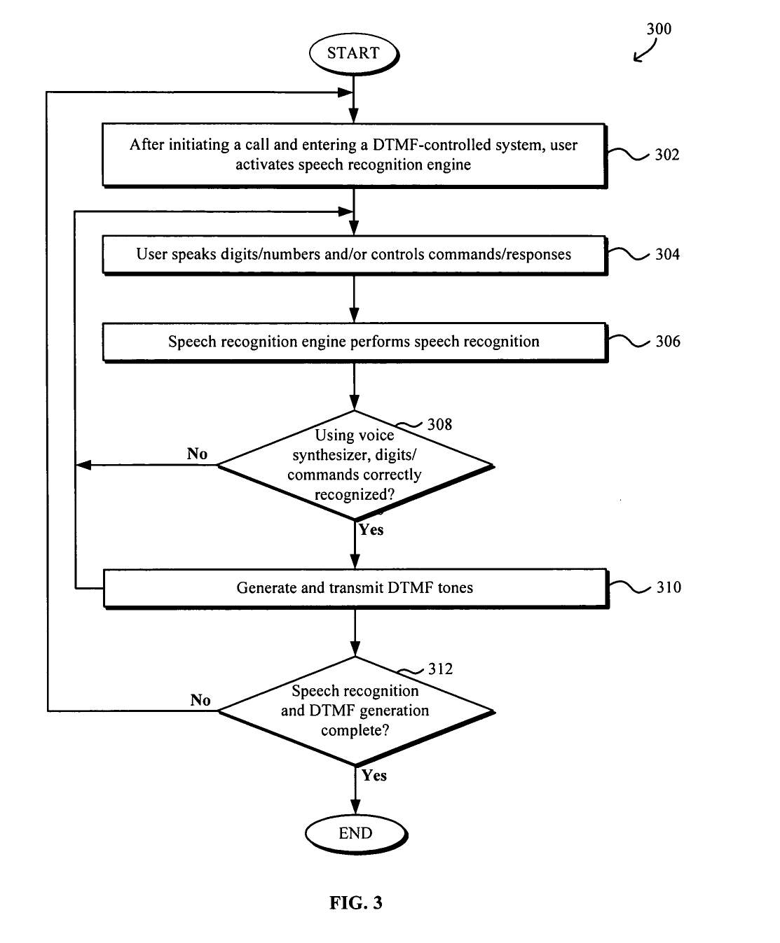

FIG. 3 is a flow chart illustrating a process 300 for translating spoken digits, numbers and/or letters to in-band DTMF tones using voice recognition technology. At block 302, the user activates the speech recognition engine after initiating a call and entering a DTMF-controlled system. The user may activate the speech recognition engine by depressing an activation button provided, for example, on the headset or headset connector and/or via a predefined verbal command that is interpreted by the speech recognition engine. Where the speech recognition engine is activated by a verbal command, the speech recognition engine preferably monitors the audio signals from the headset microphone. In contrast, where the speech recognition engine is activated by an activation button, the speech recognition engine need not monitor the audio signals from the headset microphone until after the speech recognition engine is activated.

At block 304, the user speaks digits, number, letters, and/or predefined commands or responses such as “yes,” “no,” “cancel,” “done,” etc. As noted above, the process 300 may be configured such that the user speaks all digits/numbers/letters together so that the process 300 is performed once for each navigation step of the DTMF-controlled system. Alternatively, process 300 may be configured such that the user speaks each digit or number or letter and the process 300 may be repeated several times for each navigation step of the DTMF-controlled system.

At block 306, the speech recognition engine performs speech recognition on the digits, number, letters, and/or predefined commands spoken by the user. At decision block 308, confirmation of that the digits, numbers and/or letters are correctly recognized may be performed using a voice synthesizer to speak back the recognized digits, numbers and/or letters. The user may speak back the disconfirmation with “no,” for example, which causes the process 300 to return to block 304. If the user confirms, then the process 300 continues to block 310 in which DTMF tones are generated and transmitted. The process 300 is repeated until decision block 312 determines that the speech recognition and DTMF generation is complete. The user may deactivate the touch tone navigation of the DTMF-controlled system by depressing the activation button again and/or by speaking “deactivate touch tone” or any other predefined deactivation commands, for example.

While the exemplary embodiments of the present invention are described and illustrated herein, it will be appreciated that they are merely illustrative and that modifications can be made to these embodiments without departing from the spirit and scope of the invention. For example, although the systems and methods described herein are most suitable for use with a headset, it is to be understood that the systems and methods may similarly be employed in a desktop telephone, and the like. Thus, the scope of the invention is intended to be defined only in terms of the following claims as may be amended, with each claim being expressly incorporated into this Description of Specific Embodiments as an embodiment of the invention.

1. A headset system, comprising:
a headset having a headset microphone;
a speech recognition engine configured to receive audio signals from the headset microphone and to interpret the audio signals received via the headset microphone when activated, the speech recognition engine being further configured to interpret audio signals representing at least one of digits, letters, and numbers; and
an in-band dual tone multi-frequency (DTMF) tone generator in communication with the speech recognition engine and configured to generate in-band DTMF tones representing the interpreted at least one of digits, letters, and numbers.

2. The headset system of claim 1, further comprising a DTMF activation button in communication with the speech recognition engine for activating the speech recognition engine.

3. The headset system of claim 1, wherein the speech recognition engine is activated by a voice command.

4. The headset system of claim 1, further comprising a headset base unit containing the in-band DTMF tone generator and the speech recognition engine.

5. The headset system of claim 1, wherein the headset further includes the in-band DTMF tone generator and the speech recognition engine.

6. The headset system of claim 1, further comprising a voice synthesizer in communication with the speech recognition engine.

7. The headset system of claim 6, further comprising a headset speaker in communication with the voice synthesizer, the speech recognition engine is further configured to confirm accuracy of the interpreted audio signals via the speech recognition engine and the headset speaker.

8. The headset system of claim 1, wherein the in-band DTMF tone generator generates in-band DTMF tones with a direct correspondence to the interpreted audio signals.

9. The headset system of claim 1, wherein the speech recognition engine is configured to process audio signals for a plurality of the at least one of digits, letters, and numbers and the in-band DTMF tone generator is configured to generate a plurality of in-band DTMF tones in response thereto.

10. The headset system of claim 1, wherein the speech recognition engine is configured to process audio signals for the at least one of a digit, letter, and number individually, and the in-band DTMF tone generator is configured to generate an in-band DTMF tone in response thereto.

11. The headset system of claim 1, wherein the speech recognition engine is further configured to interpret a predefined set of commands and/or user responses.

12. A method for navigating through a dual tone multi-frequency (DTMF) controlled system, comprising:
activating a speech recognition engine;
interpreting speech received via a microphone from a user by the speech recognition engine, the speech recognition engine being configured to interpret the speech representing at least one of digits, letters, and numbers; and
generating and transmitting in-band DTMF tones representing the interpreted speech by an in-band DTMF tone generator in communication with the speech recognition engine.

13. The method of claim 12, wherein the activating the speech recognition engine is via a DTMF activation button in communication with the speech recognition engine.

14. The method of claim 12, wherein the activating the speech recognition engine is via voice command from the user.

15. The method of claim 12, further comprising, prior to the generating and transmitting, confirming accuracy of the speech interpreted by the speech recognition engine by generating the interpreted speech via a voice synthesizer.

16. The method of claim 12, wherein the in-band DTMF tone is direct translation of the interpreted speech.

17. The method of claim 12, wherein the speech recognition engine is configured to process speech for a plurality of the at least one of digits, letters, and numbers and the in-band DTMF tone generator is configured to generate a plurality of in-band DTMF tones in response thereto.

18. The method of claim 12, wherein the speech recognition engine is configured to process speech for the at least one of a digit, letter, and number individually, and the in-band DTMF tone generator is configured to generate an in-band DTMF tone in response thereto.

19. The method of claim 12, wherein the speech recognition engine is further configured to interpret a predefined set of commands and/or user responses.

20. A method, comprising:
connecting to a DTMF-controlled system, in which navigation through the DTMF-controlled system is via transmission of DTMF tones thereto;
interpreting speech by a speech recognition engine configured to receive speech from a user; and
generating and transmitting in-band DTMF tone to the DTMF-controlled system, the in-band DTMF tones being a translation of the interpreted speech selected from at least one of digits, letters, and numbers.

21. The method of claim 20, further comprising, after the connecting, activating the speech recognition engine.

22. The method of claim 20, further comprising, prior to the generating and transmitting, confirming accuracy of the speech interpreted by the speech recognition engine by generating the interpreted speech via a voice synthesizer.

23. The method of claim 20, wherein the in-band DTMF tone is a direct translation of the interpreted speech.

24. The method of claim 20, wherein the speech recognition engine is configured to process speech for a plurality of the at least one of digits, letters, and numbers and the in-band DTMF tone generator is configured to generate a plurality of in-band DTMF tones in response thereto.

25. The method of claim 20, wherein the speech recognition engine is configured to process speech for the at least one of a digit, letter, and number individually, and the in-band DTMF tone generator is configured to generate an in-band DTMF tone in response thereto.

26. The method of claim 20, wherein the speech recognition engine is further configured to interpret a predefined set of commands and/or user responses.
